(19) United States
(12) Patent Application Publication
(10) Pub. No.: US 2009/0083170 A1
(43) Pub. Date: Mar. 26, 2009

(54) PRODUCT AND SERVICE MANIPULATION FOR OPPORTUNITY PURSUIT

(75) Inventor: Robert J. Ortega, Moravian Falls, NC (US)

Correspondence Address: AMIN, TUROCY & CALVIN, LLP, 127 Public Square, 57th Floor, Key Tower, CLEVELAND, OH, 44114, US

(73) Assignee: WACHOVIA CORPORATION, Charlotte, NC (US)

(21) Appl. No.: 11/861,969

(22) Filed: Sep. 26, 2007

(51) Int. Cl. G06Q 40/00

(52) U.S. Cl. 705/35

(57) ABSTRACT

When pursing a financial opportunity, certain products and/or services can be used in helping different parties to achieve a related benefit. Since a number of different products and/or services can be available, selection is made to improve a likelihood of success with the financial opportunity. Once there has been an appropriate selection, the products and/or services can be configured to increate a likelihood of success.

### CROSS-REFERENCE

This application relates to attorney docket application no. WB2007022013/WACHP114US entitled “FINANCIAL OPPORTUNITY INFORMATION OBTAINMENT AND EVALUATION”. The entirety of which is incorporated by reference herein.

This application relates to attorney docket application no. WB2007022017/WACHP116US entitled “ECONOMIC OPPORTUNITY PURSUIT MANAGEMENT AND PRESENTATION GENERATION”. The entirety of which is incorporated by reference herein.

This application relates to U.S. patent application Ser. No. 11/832,600 entitled “ONLINE ORIGINATION MACHINE” filed on Aug. 1, 2007. The entirety of which is incorporated by reference herein.

### TECHNICAL FIELD

The subject specification relates generally to pursuit of a financial opportunity and in particular to selecting and configuring products and/or services for pursuit of the financial opportunity.

### BACKGROUND

If a person would like to gain capital, then a loan can be taken out that provides the person desired funds. A loan is typically an upfront payment of a sum of money, where a borrowing party returns the money over a period. To make a profit on a loan transaction, a lender can charge interest that forces the borrowing party to pay back a sum greater then what is loaned. Other techniques can be employed to gain money for a borrowing party, such as adding on additional interest to combat inflation, placing on fees that are detrimental to a borrowing party paying a loan back early, etc.

Commonly, loans are based off collateral; if a borrowing party defaults on a loan, then a lending party takes legal possession of the collateral. Commonly, the collateral can be an item purchased with loaned money. For instance, if a party takes out a loan to purchase a home and the borrowing party fails to make proper payments, then a lender can sell the home to even the loan. Excess profit from the home sale can be provided to the borrowing party.

For a party in need of capital, other methods of obtainment are possible. If the party is a relatively successful company, then an Initial Public Offering can be used to allow shares of the company to be traded upon a public market. A company uses money gained from a sale of shares for business purposes; typically, a board of directors and/or a bound officer dictates decisions on monetary expenditures.

In addition, a party can receive other financial benefits aside from a loan. Accountants can be employed to assist in preparing taxes while stock market brokers can be used to assist in determining where money should be invested. A lawyer can aid in creating a business structure that limits liability and/or lowers taxes (e.g., a limited liability company).

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventionally, when a financial opportunity is to be pursued, a professional broker determines what services and/or products are to be suggested to a client. There are several drawbacks to the conventional manner, which hamper productivity and inhibit profits. Dedicating a human resource to a financial opportunity can be expensive due to high salaries, low profit margin, large time commitment, etc. In addition, since a large amount of information can be related to a financial opportunity; there is a relatively high likelihood that a human will miss details concerning a financial opportunity and therefore selection will be of lower quality.

The disclosed innovation allows for automatic selection of at least one product or at least one service for pursuit of a financial opportunity (e.g., small financial opportunities, obscure financial opportunities, opportunity types not commonly pursued, etc.). Information relating to a financial opportunity is evaluated and based on analyzed information, at least one product/service is selected that can be used in reaching a successful conclusion upon a financial opportunity. Selected products/services commonly have parameters (e.g., price level, amount of time for execution, etc.) that are to have settings specific to a financial opportunity. The disclosed innovation allows parameters to be set at levels to complete a financial opportunity in a beneficial manner.

The disclosed innovation goes against current market trends and developments. Product/service selection, parameter configuration, and determining financial opportunities to pursue are performed by people due to the importance of a possible outcome (e.g., a transaction becoming profitable, a company taking a loss on a financial deal, etc.). For instance, an hourly rate difference of several dollars can be a deciding factor if a client will choose a service (e.g., a client that relates to a financial opportunity). Since small details can become important, it seems illogical to automate aforementioned tasks. However, thorough careful automatic analysis and determination (e.g., determining what opportunities to pursue, what products/services to pitch, parameters for products/services), an unexpected result is produced such that enough quality fiscal possibilities can be pursued to make practicing the innovation profitable and thus beneficial.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative product selection system in accordance with an aspect of the subject specification.

FIG. 2 illustrates a representative appreciation component in accordance with an aspect of the subject specification.

FIG. 3 illustrates a representative match component in accordance with an aspect of the subject specification.

FIG. 4 illustrates a representative a representative product selection system with a cost component in accordance with an aspect of the subject specification.

FIG. 5 illustrates a representative financial opportunity pursuit system in accordance with an aspect of the subject specification.

FIG. 6 illustrates a representative product and/or service manipulation methodology in accordance with an aspect of the subject specification.

FIG. 7a illustrates a first part of a representative financial opportunity pursuit methodology in accordance with an aspect of the subject specification.

FIG. 7b illustrates a second part of a representative financial opportunity pursuit methodology in accordance with an aspect of the subject specification.

FIG. 7c illustrates a third part of a representative financial opportunity pursuit methodology in accordance with an aspect of the subject specification.

FIG. 8 illustrates an example of a schematic block diagram of a computing environment in accordance with the subject specification.

FIG. 9 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components. As used in this application, the terms “product” and “service” are to have reciprocal descriptions. For example, if a product is described as having certain capabilities such as a price, then it is to be appreciated that a service can inherently have the same and/or similar capabilities unless stated otherwise.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

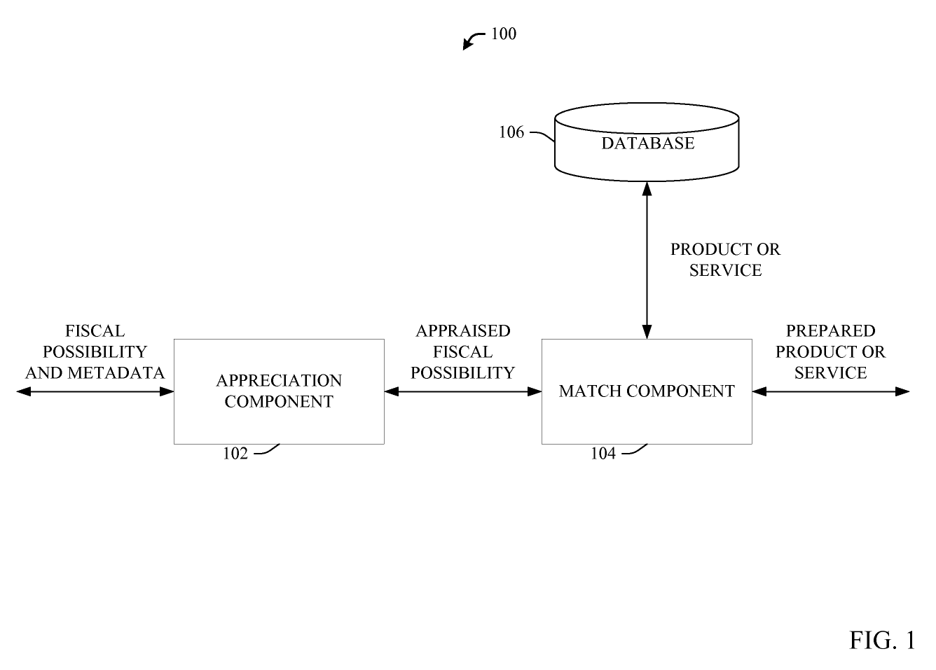

FIG. 1 discloses an example system 100 for manipulating products and/or services for pursuit of a financial opportunity. A relatively large number of financial opportunities are commonly not pursued for various reasons (e.g., small size, limited profit potential, obscure industry, not enough resources, in an industry not commonly engaged, etc.). However, automatically gathering information and evaluating financial opportunities based on gathered information allows an organization to take advantage of a greater number of financial opportunities. To attempt to increase likelihood that a financial opportunity will be advantageous, proper analysis and product/service selection can be performed automatically. Products and services that match a financial opportunity can be pitched to a potential client in order for multiple parties to be content with an outcome of the financial opportunity.

According to one embodiment, financial opportunities are investment banking opportunities such as underwriting (e.g., debt or equity), Initial Public Offerings, Merger & Acquisition advising; Private equity; Finance re-structuring, etc. Opportunities can include bringing a company public or bringing a company private, determining which two companies would do better together, which company will do better broken apart, etc. A goal of a financial opportunity can be to receive authorization for an investment bank to represent a client on a matter. Potential financial opportunities (e.g., investment baking opportunities) can be collected via a rules based and/or semantic search engine, Internet browser based application for investment banking, service request capture, Internet browser based application for capturing investment banking opportunity referral, etc.

A financial opportunity as well as metadata related to the financial opportunity (e.g., information on which the financial opportunity is based, estimations related to the financial opportunity, information on another company involved with the financial opportunity, etc.) enter an appreciation component 102. The appreciation component 102 appraises a fiscal prospect designated for engagement; commonly appraisal is at least in part concerning products and/or services that will be used for pursuit of the fiscal prospect.

A fiscal prospect can have a number of different characteristics that can become important in relation to pursuit. For instance, a fiscal opportunity can be to loan money to a company to increase production for a product. A loan can have different parameters depending on a company associated with the financial opportunity (e.g., a company that will receive the loan). For instance, a loan interest rate can be determined by company debt, available collateral, estimated highest rate company will accept, approximations on interest rates from competitors, etc. The appreciation component 102 determines at least one characteristic that can be used in matching the financial opportunity with at least one product and/or service.

An appraised fiscal possibility transfers to a match component 104 that selects at least one product or service for engagement based at least in part on a result of the appraisal. To increase likelihood that a financial opportunity will be successful, an appropriate product and/or service is selected. The match component 104 can access a database 106 that holds a list of available products and/or services. In addition to learning what products or services are available, the match component 104 can learn parameters concerning products or services located in the database 106 (e.g., that a loan commonly has an associated term range, such a three to thirty years).

In an illustrative example of operation of the system 100, a financial opportunity can be a relatively successful small company has a potential to expand if they receive an influx of capital. The appreciation component 102 performs various analyses upon a received fiscal possibility and associated metadata. Results of the analyses can transfer to the match component 104, where the match component 104 accesses different possible products and/or services, which can be obtained from a variety of sources (e.g., from the database 106, through a data network via wireless communication, etc.).

In the example, there can be a possible product of configuring an Initial Public Offering (IPO) and a possible service of having a financial manager review outstanding debts to determine if consolidation is possible. The match component 104 reviews results of the analyses performed by the appreciation component 102. For instance, a common IPO has various requirements, such as a company has a certain revenue level; the match component 104 determines if the small company possesses a required revenue level. If the small company does not meet requirements, then the IPO product can be disregarded.

The match component 104 can also determine if the product and/or service is suitable for the small company. If the small company is run by a father who started the company so it could be a family business and be ultimately taken over by his daughter, then it is unlikely the father will want to make the company public since it would likely mean diminished control for the daughter. Information concerning the small company (e.g., that a father started the company for his daughter) can be learned by the appreciation component 102. The match component 104 determines and IPO is likely not the best route (e.g., since it goes against a business plan of the small company) and selects the financial manager review service.

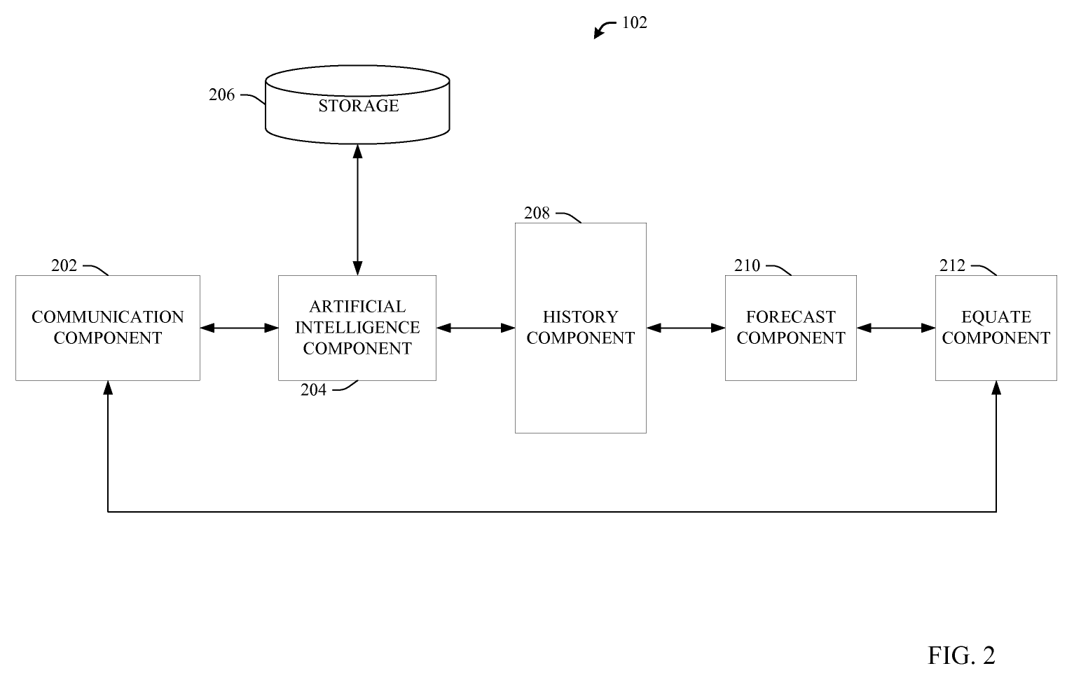

FIG. 2 discloses an example appreciation component 102 in accordance with an aspect of the subject specification. A communication component 202 enables the appreciation component 102 to interact with other units. The communication component 202 can be utilized to enable devices of the collection component 102 to engage other devices (e.g., an analysis component) in a wireless manner, through a hard wire configuration, etc. Security features can be implemented by the communication component 202, such as checking for errors that can disrupt the appreciation component 102 (e.g., viruses).

An artificial intelligence component 204 makes at least one inference or at least one determination in relation to selection of at least one product or service. Various scenarios can occur that are processed by the artificial intelligence component 204. For example, the artificial intelligence component 204 can learn that a financial opportunity involves a company that is headed by a person who prefers working alone; a determination can be made that a service involving interaction with multiple individuals should not be selected. In another example, the artificial intelligence component 204 can receive information that a company that relates to a financial opportunity has few financial resources. An inference can be made that a relatively expensive product should not be picked.

Artificial intelligence component 204 can employ one of numerous methodologies for learning from data and then drawing inferences and/or creating making determinations related to association of a representation (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems. A rules based investment banking product matching software engine, rules based investment banking presentation scheduler engine, and/or automated investment banking pitchbook presentation generation are examples of aspects that can be implemented through artificial intelligence techniques.

The appreciation component 102 can utilize storage 206 to hold information relevant to operation. Storage 206 can be flash memory, hard disk, magnetic tape, etc. Various components can use the storage 206 for operation. For instance, the communication component 202 can hold location information, where location information is used various components (e.g., an appropriate match component 104 of FIG. 1).

A history component 208 evaluates previous interactions related to a fiscal prospect and provides historic data of the pervious interactions to the match component 104 of FIG. 1, where historic data is used in selection of at least one product or service. When a selected product/service is presented to a client, the client will have a reaction (e.g., purchase the product/service, reject the product/service, modify combinations of products and services, change parameters of a product/service, silence, etc.). The history component 208 can learn tendencies concerning reactions and submit reaction information to the match component 104 of FIG. 1. For example, the match component 104 of FIG. 1 can have selected a loan product for about ten similar fiscal prospects. About ten of the fiscal prospects rejected the product because the interest rate was too high. The history component 208 can identify the reason and use the artificial intelligence component 204 to infer that loan interest rates should be lower. The history component 208 can utilize the communication component 202 to notify the match component 104 of FIG. 1 that interest rates should be lower.

A forecast component 210 can make a prediction on a likelihood of success for a fiscal prospect. A likelihood of success prediction can be influential in product/service selection. An economic occasion designated for pursuit can be high risk and have a low likelihood of success (e.g., being accepted by a client, producing a profit, etc.). Since there is a low likelihood of success, the match component 104 of FIG. 1 can make riskier selections (e.g., selections that can have more profit, but have a lower chance of being accepted) due to the low likelihood of success.

An equate component 212 evaluates the fiscal prospect (e.g., determines how valuable the prospect is, discovers a speculative level for the fiscal prospect, etc.). The equate component 212 can produce metadata that relates to the fiscal prospect. In an illustrative example, the equate component 212 determines that a financial opportunity could produce other business outside of the initial opportunity. A notification can be sent to the match component 104 of FIG. 1 concerning the importance of the opportunity and possible suggested operation (e.g., set parameters that could result in a loss, because an overall gain could still take place considering multiple transactions).

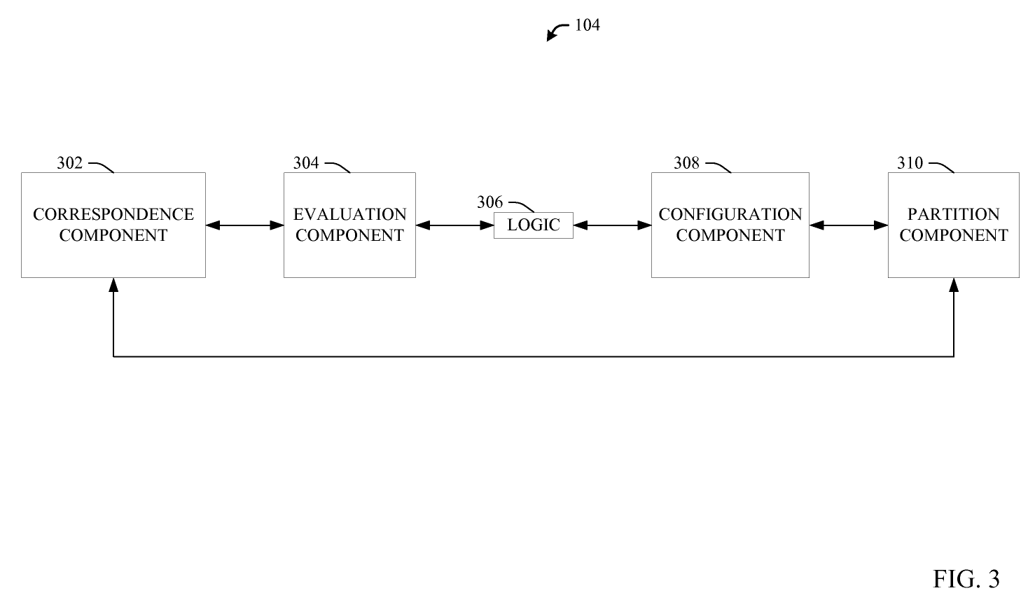

FIG. 3 discloses an example match component 104 in accordance with an aspect of the subject specification. A correspondence component 302 enables the match component 104 to interact with other units. The correspondence component 302 can be utilized to enable devices of the match component 104 to engage other devices (e.g., an analysis component that evaluates potential opportunities by performing rules based analysis.) in a wireless manner, through a hard wire configuration, etc. Security features can be implemented by the correspondence component 302, such as checking for errors that can disrupt the match component 104 (e.g., viruses).

An evaluation component 304 analyzes at least one service or at least one product, where a result of the analysis is used in selection of at least one product or service. The database 106 of FIG. 1 can feed directly into the evaluation component 304; in addition, the evaluation component 304 can possess search capabilities and discover available products and services from a plurality of locations. Obtained (e.g., downloaded, discovered, etc.) products/services are evaluated in accordance with a financial opportunity. The evaluation component 304 learns various characteristics concerning a product and/or service.

Logic 306 determines at least one product or at least one service that can be used in pursuit of an economic prospect. Logic 306 is used to make a selection of at least one product/service that can be presented to a party related to an economic prospect (e.g., a combination of complementing services and products). Logic can include various algorithms and other capabilities (e.g., practicing artificial intelligence techniques) to select appropriate products and/or services.

A configuration component 308 arranges at least one parameter related to the selected product or service. Commonly, products and services have various parameters, such as price, longevity, etc. The configuration component 308 places values (e.g., numerical values, level such as high or low, etc.) for appropriate parameters. For instance, if a service is for consultation from a licensed attorney, then the configuration component 308 can choose an attorney to provide consultation.

A partition component 310 assigns the selected product or service to an entity. A fiscal opportunity can have one entity, thus the partition component 310 assigns the product/service to the one entity. However, if there are multiple entities involved, the partition component 310 can choose at least one entity for association. For example, a financial prospect can have a parent company and a subsidiary company. A loan can be offered to the subsidiary that can benefit from funds while related consultation is offered to the parent company to limit liability.

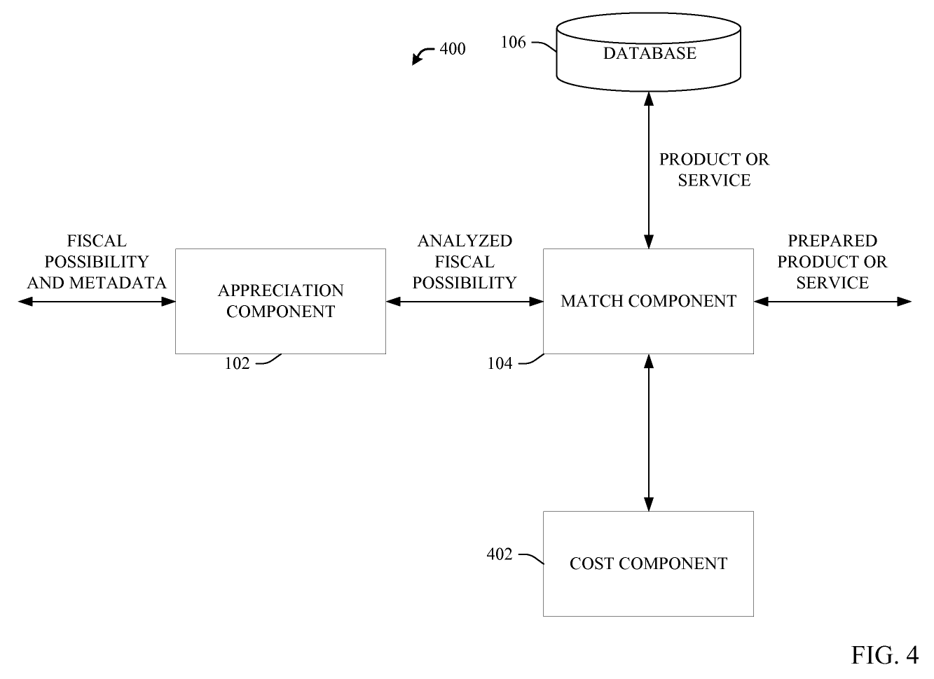

FIG. 4 discloses an example product/service selection system 400 with a cost component 402. A fiscal possibility and metadata relating to the fiscal possibility enter into an appreciation component 102. The appreciation component 102 appraises a fiscal prospect designated for engagement. Commonly appraisal can take place through analysis of the fiscal possibility and related metadata. The analyzed fiscal possibility that can include metadata transfers to a match component 104. The match component 104 selects at least one product or service for engagement of the fiscal prospect based at least in part on a result of the appraisal. In order to determine what products and/or services are available, the match component 104 can access a database 106 that holds information related to products and services. Ultimately, the match component 104 produces a prepared product and/or service (e.g., or a combination thereof) or outputs and notice that an appropriate product and/or service could not be discovered.

The match component 102 can also utilize a cost component 402 in facilitating operation. The cost component 402 provides economic data to the match component, where economic data is used in selection of at least one product or service. Various amounts of information can be useful to the match component 104 that relate to economic data.

According to one embodiment, economic data relates to an overall fiscal market. For instance, when determining what loan interest rate should be provided to a client, it can be important to know a rate being charged by a reserve bank. The cost component 402 discovers the reserve bank rate, transfers reserve bank rate information (e.g., that rate, when the rate is expected to change, etc.), and the mach component can use the rate in determining an interested rate to association with a product.

However, it is possible that the cost component 402 determine economic data as it relates to an entity relevant in the fiscal possibility. For example, in determining what services to provide to a company, it can be useful to understand if the company owns real property that can be used as collateral. The cost component 402 can search through real estate records to determine what is owned by the company as well as individuals associated with the company (e.g., a majority shareholder). Real property information can transfer to the match component 104 and the match component 104 can use the real property information in determining a potential product and/or service (e.g., a higher loan backed with real property as collateral).

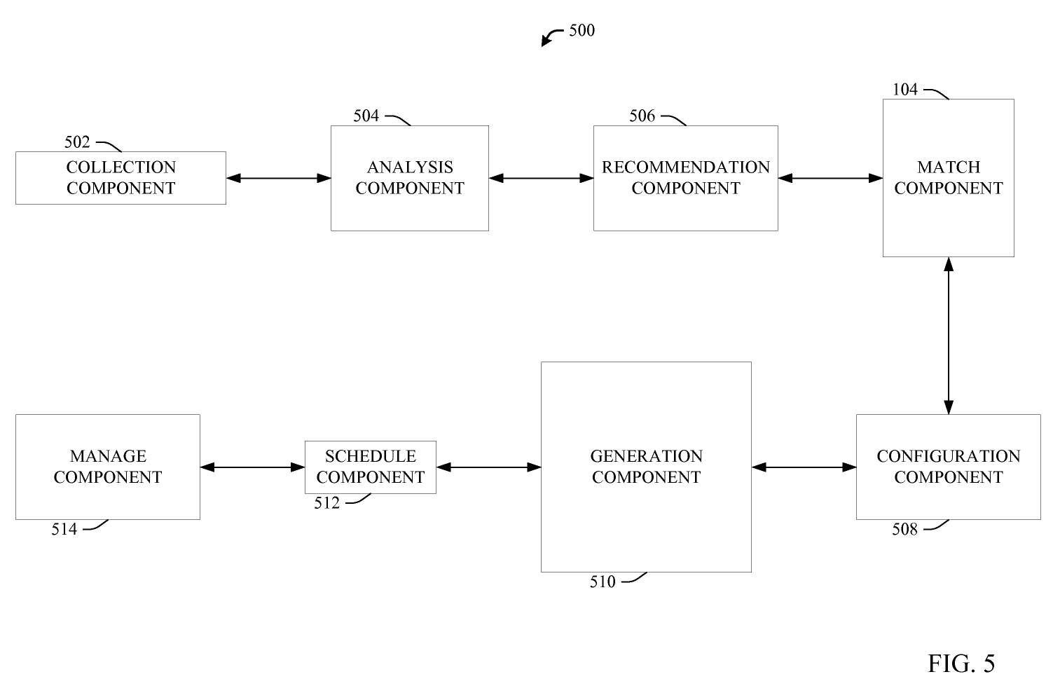

FIG. 5 discloses an example system 500 for processing of a fiscal prospect. A collection component 502 obtains information from a network. Information is typically gathered from a plurality of sources and transferred to analysis component 504 for evaluation. Information can be gathered from a user submission, from monitoring communication traffic, actively searching websites, etc. The collection component 502 can operate as a means for collecting information that associates with an entity.

The analysis component 504 evaluates the obtained information as a function of a financial opportunity. A set of rules is applied upon obtained information to determine if a financial opportunity should be pursued. The rules can be modified by a user or automatically if desirable results are not being achieved (e.g., bad fiscal prospects are pursued, good financial projects are being rejected, etc.). A decision if the financial opportunity should be pursued is made and the financial opportunity can be held for further observation, disposed, transferred to other portions of the system 500, etc. The analysis component 504 can include the appreciation component 102 of FIG. 1 that appraises a fiscal prospect designated for engagement. The analysis component 504 can operate as a means for determining if a financial opportunity related to the entity should be pursued as well as a means for evaluating at least one condition pursuant to the financial opportunity.

If a financial opportunity is not to be pursued by a construct running the system 500, then a recommendation component 506 refers the financial opportunity to an auxiliary provider. The recommendation component 506 can rely on a selection component to choose at least one entity in which the recommendation component 506 can refer a financial opportunity. A recommendation can include evaluation information, however, a mere referral can also be provided. The recommendation component 506 can operate as a means for referring the financial opportunity if it is determined that the financial opportunity should not be pursued in-house; in-house can include another division of one organization as well as another organization. For example, if a financial opportunity is not pursued by an investment bank division, then it is referred to a commercial bank division, where the investment bank division and commercial bank division are part of one company.

If a referral does not take place and the system 500 is to continue in pursuit of a financial opportunity, then a match component 104 operates. The match component 104 selects at least one product or service for engagement of a fiscal possibility, commonly based off a result of the analysis component 504. A company can desire to gain capital to increase production. One option can be to take out a bank loan while another option can be to generate capital by taking the company public. The match component 104 selects a product or service that is appropriate for pursuit of the fiscal possibility. According to one embodiment, the match component 104 find a maximum combination of at least one service or at least one product (e.g., maximize profit for an investment firm, maximize profit as a function off hours spent, increase likelihood fiscal possibility will not operate at a loss, etc.). The match component 104 can operate as a means for choosing at least one product or at least one service for pursuit of the financial opportunity.

A configuration component 508 arranges at least one parameter related to the selected product or service. Based on an outcome of the match component 104, a selected product or service has parameters that are to be established. For instance, the match component 104 can select a loan for providing capital to a company. The configuration component can establish term of the loan, interest rate of the loan, suggest collateral for the loan, etc.

Knowledge of a product or service for user can be useful in creating a presentation. A generation component 510 creates a presentation that relates to the fiscal possibility based upon the obtained information. A presentation can be used to convince a client to engage in a transaction with an investment firm operating the system 500 (e.g., allows the investment firm to gain benefits of the financial opportunity). While stated as being operated by a company pursuing a financial opportunity, it is to be appreciated that aspects of the subject specification can take place by a third party on behalf of an entity (e.g., investment company). Example presentations include digital slide arrangements, folders, pamphlets, videos, sketch drawings, etc. The generation component 510 can function as a means for generating a presentation for use in pursuit of the financial opportunity.

A schedule component 512 organizes time of at least one person as a function of a fiscal possibility, where the person with organized time relates to the created presentation. While a presentation generates automatically, it can be beneficial to have at least one individual designated to disclosing the presentation to a prospective client. In addition, the schedule component 512 can designate a person to supervise a financial opportunity. The schedule component 512 can view metadata relating to different people based on analysis of the metadata, a person can be designated to a financial opportunity and a portion of their time can be allotted to the opportunity. For instance, the schedule component 512 can view time allotments, priority notices, previous experience, etc. in determining an individual to designate to a project (e.g., designation by filling calendar time for a person with time for the financial opportunity). The schedule component 512 can operate as a means for assigning a portion of time of at least one person, where assigned time is dedicated to pursuit of the financial opportunity.

A manage component 514 regulates at least one auxiliary task associated with the presentation. Commonly, a number of different tasks take place following disclosure of a presentation. Example tasks include transmitting follow-up correspondences, scheduling supplemental telephone calls, docketing events that occur after the presentation, etc. The manage component 514 can operate as a means for managing workflow that relates to pursuit of the financial opportunity.

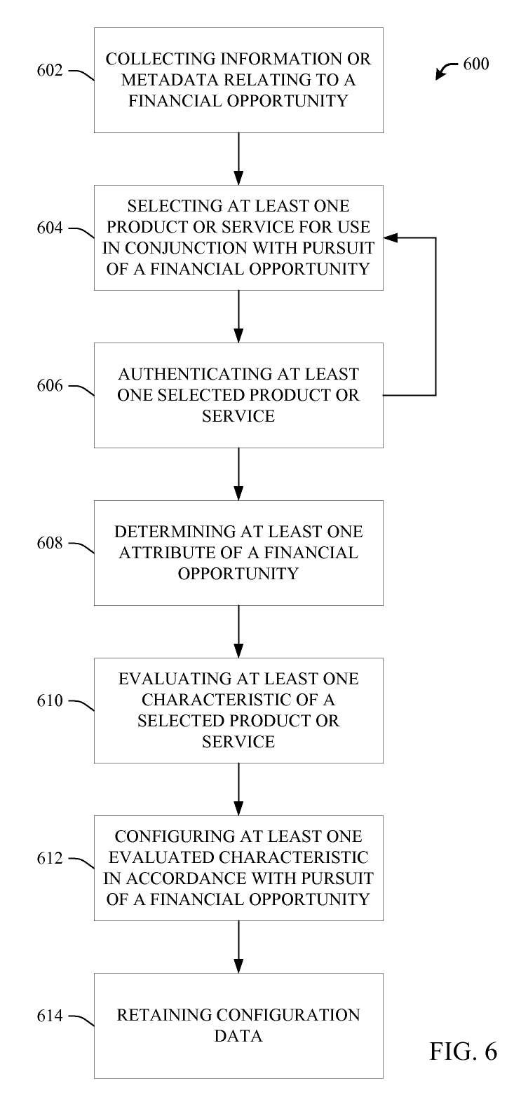

FIG. 6 discloses an example methodology 600 for configuring at least one selected product and/or at least one selected service. There is collecting information or metadata relating to a financial opportunity 602. Example collected information can include context of the financial opportunity, available products and/or services, history relating to available products and/or services, etc.

Selecting at least one product or service for use in conjunction with pursuit of a financial opportunity 604 occurs. Act 604 operates to increase (e.g., maximize) benefit of a financial opportunity. For instance, analyzing a financial opportunity takes place and based on the analysis, selection occurs. Selection can operate in an independent manner (e.g., selection of a number of products and services based on analysis of a fiscal prospect), dependent manner (e.g., selection of products/services that complement one another), independent and dependent, etc. In an illustrative instance of an independent manner, a tax product and a loan product can be selected where there selection of one is not intended to complement the other. For a dependent manner, a tax product is selected as well as a consulting service of a Certified Public Accountant to explain the tax product and answer questions.

Authenticating at least one selected product or service 606 takes place. It is possible that a service/product is selected incorrectly; as an illustration, a company related to a fiscal prospect has a noted desire not to take on more debt, which was not known at selection time. Selection of a loan product would be detrimental, since it has a low likelihood of being accepted and can be detrimental to a relationship with the company. Event 606 can refuse authentication and return the methodology 600 to event 604.

Event 608 is determining at least one attribute of a financial opportunity. Different attributes can be related to the financial opportunity; example attributes can include an anticipated price a company would like to spend, an existing relationship with the company, etc. An analysis takes place so various attributes can be determined (e.g., practicing comparative analysis against discovered pieces of information relating to the opportunity, making estimations upon the opportunity as a whole, etc.).

There is evaluating at least one characteristic of a selected product or service 610. Conventionally, products and/or services have a number of associated characteristics. In an illustrative example, a selected service can be to have a consultant determine foreign markets that should be pursued by a small company. Possible characteristics that can be evaluated are a level of experience for the consultant, an amount of time the consultant will dedicate, a rate type, a rate amount, etc.

Configuring at least one evaluated characteristic in accordance with pursuit of a financial opportunity 612 occurs. Characteristics can be populated in accordance with a goal of achieving a financial opportunity. If a characteristic of a product is rate amount, then detailed analysis can take place to determine what should be supplied as an amount. A characteristic can then be configured in line with the determination. In one example, a price type can be determined and then populated into a product profile holding information of the product. Secondary actions can also take place, such as modifying a price into an appropriate currency.

Action 614 is retaining configuration data; retained configuration data can be used in subsequent configuration of at least one evaluated characteristic in accordance with pursuit of a financial opportunity. In an illustrative instance, a loan product is selected and configured by the methodology 600. Event 614 retains information relating to the product and observes a response to a product (e.g., was the product acceptable, was the financial opportunity profitable, etc.). Observations can be used to determine further selection and configuration. If a loan product was too expensive and/or undesirable, then actions can alter their practice to attempt to change reaction information to a product and/or service.

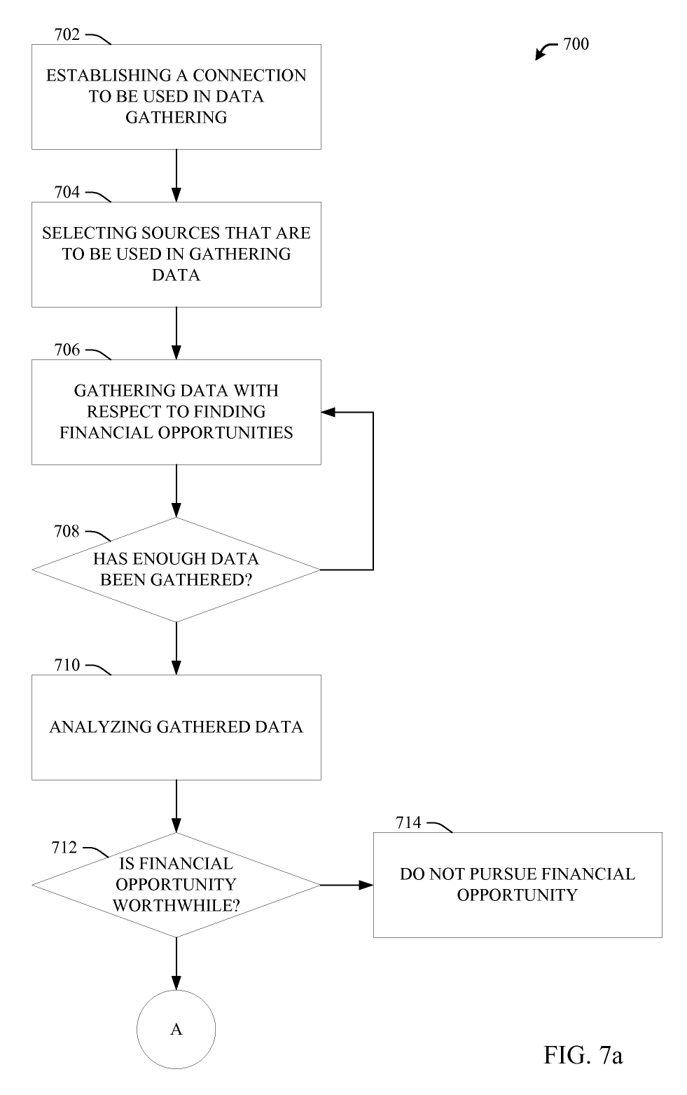

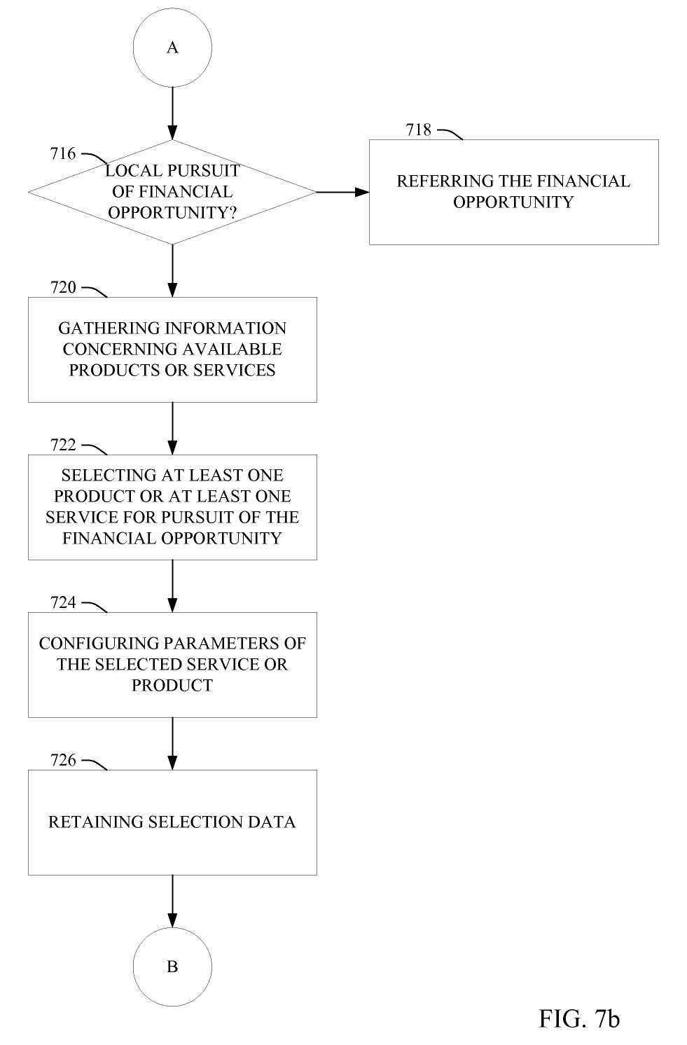

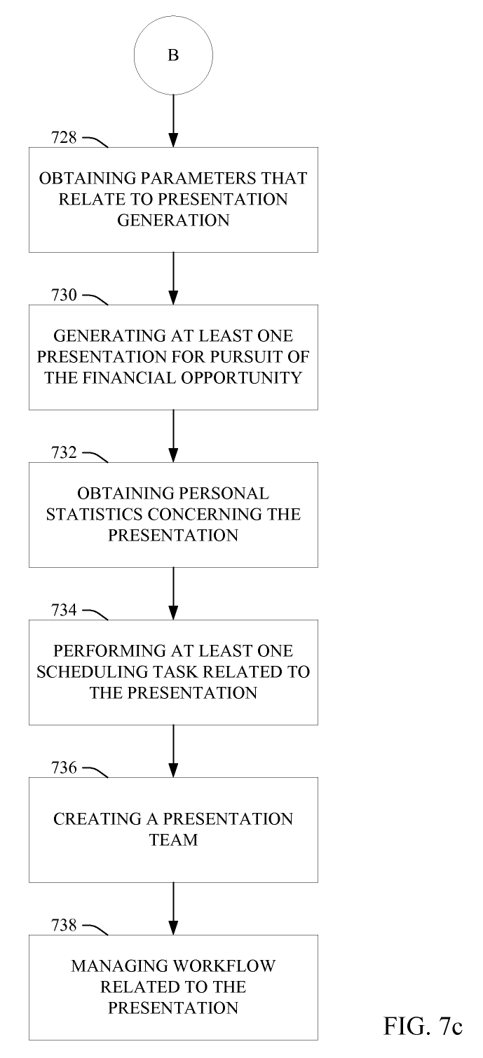

FIG. 7a, FIG. 7b, and FIG. 7c disclose an example methodology 700 for performing actions upon a financial opportunity. There is establishing a connection to be used in data gathering 702. In order to gathered data, it is common to establish an electronic link to allow for information gathering. Example connections include “logging-on” to the Internet, configuring with a monitor to receive user input, integrating with a scanner to receive optical images of information, etc.

Selecting sources that are to be used in gathering data 704 occurs. A large number of sources transferring information to a system operating the methodology 700 can become overwhelming and slow down system operation. To minimize consumption of system resources in information gathering, some sources can be eliminated as suppliers of information. For instance, a financial report website can be signaled as a source that historically produces quality information; therefore, the financial report website is selected for data gathering. However, a social networking website can produce little information on financial opportunities, so the social networking website is deselected for information gathering (e.g., information is not gathered from the social networking website).

Gathering data with respect to finding financial opportunities 706 can take place. Data obtainment can occur according to a number of different embodiments. Passive observance of communications occurs, where observed communications are subjected to a semantic search. It is to be appreciated that use of a semantic search is disclosed as an example and other implementations can be practiced. Information sources can be actively scoured according to a semantic search to determine relevant information that is then extracted. Receiving communications intended to be included in gathered information, such as an input request from an entity (e.g., filling out a form presenting a financial opportunity), can be obtained. It is to be appreciated that other obtainment configuration can be practiced to gather information.

A check 708 takes place to determine if enough information has been gathered to perform an accurate evaluation of the financial opportunity. An amount of information is compared against an established standard. For instance, a system operating the methodology 700 can have a standard that if a fiscal prospect has an expected profit of about $1,000,000 US Dollars, then about fifty pieces of any quality of information should be gathered for the check to be cleared. If enough information has not been gathered, then the methodology 700 can retract to event 706 to gather more information (e.g., gather enough information to be accepted by the check 708).

There is analyzing gathered data 710; rules are applied against a subset of gathered data and various inferences and determinations are made as a result or application of the rules. In an illustrative example, a subset of gathered data that is the whole set is applied with a rule disclosing that if three or more United States patent applications are filed towards a product, then there is a high likelihood there is licensing potential. Therefore there can be an indication that a related financial opportunity (e.g., financing a loan for production of the product) is worthwhile.

Verification 712 determines if a financial opportunity is worthwhile to pursue. A variety of different factors can be taken into account to determine if a fiscal prospect with a worthwhile endeavor. For instance, results of analyzing gathered data 710 can be provided a numerical result (e.g., positive for results that indicate the opportunity should be pursued, negative if the opportunity should not be pursued). Numerical results can be summed together and a final number can indicate if the opportunity should be pursued.

A result of the verification 712 can be relative low and thus the methodology 700 instructs a system not to purse the financial opportunity 714. Action 714 can be a permanent conclusion as well as a temporary conclusion. As a permanent conclusion, the financial opportunity is disposed of and no longer considered active. A message can be transferred indicating the financial opportunity should not be re-evaluated. However, action 714 can transfer back to 706 where more information is gathered and further evaluations take place.

A check 716 can take place to determine a party that should pursue the financial opportunity. While a fiscal prospect can be beneficial, there are possible situations that would make local pursuit too risky, difficult, etc. For example, a fiscal opportunity with a projected razor thing profit margin could be too risky for pursuit of a large investment firm. However, smaller firms can desire to pursue the low profit margin deals and the large investment firm can refer the financial opportunity to smaller firms who pay a fee (e.g., a monthly fee to receive a referral list).

There is typically referring the financial opportunity 718 to another party. This often takes place when there is not to be local pursuit; however, it is possible for there to be both local pursuit and a referral. Referral can take place to at least one or more entities where the referral includes limited information (e.g., opportunity and critical information, such as company name) as well as detail information about the opportunity (e.g., why the opportunity is considered worthwhile, why a firm operating the methodology 700 is not pursing the opportunity, etc.). A record can be made in storage concerning a party that received a referral as well as how they responded to the referral (e.g., did the party purse the referral).

There is gathering information concerning available products or services 720. If a financial opportunity is to be pursued, then certain products and or services can be used to improve (e.g., maximize) an outcome for the financial opportunity. A database can be accessed of available products and service and a list can be provided containing different possibilities. If a company would like to develop a franchise model where investors purchase franchise rights to run a company branch in an area, then a possible product can be a loan for investors to cover a franchise fee. If a company is having accounting difficulties, then a software product can be recommended that allows the company to streamline accounting procedures.

Selecting at least one product or at least one service for pursuit of the financial opportunity 722 takes place; the selection can take place automatically though trained logic. A number of factors can be used in determining an appropriate service and/or product. For instance, a construct related to the financial opportunity can be operating on a limited budget. Therefore, choices are made with total cost of products/services in mind. However, if a company is unsophisticated, then a combination of too many products and/or services can be overwhelming, so an attempt can be made to select a single product or service so pursuit does not become overcomplicated.

Configuring parameters of the selected service or product 724 takes place. A variety of parameters can associate with a selected product and/or service; these selected parameters can be influential in determining if a financial opportunity is realized (e.g., a potential clients purchases a selected product and/or service). For example, if a loan is selected as a product, the interest rate on the loan can determine success of the financial opportunity. If the interest rate is too high, then the client could be unlikely to purchase the produce. However, if the interest rate is too low, then the financial opportunity can become unprofitable and/or become wasteful (e.g., resources are dedicated to this financial opportunity while the resources could have been dedicated to a more fruitful fiscal prospect). Therefore, event 724 can attempt to configure the selected product/service in manner that improves usefulness of the financial opportunity.

There is retaining selection data 726 that enables monitoring of an outcome for the financial opportunity. If a parameter was selected and an undesirable outcome was achieved (e.g., a selected product and/or service was not purchased by a potential client relating to the financial opportunity), then there can be an indication that a parameter was incorrectly selected. Parameter selection logic can be modified in order to produce improved results. Testing of modifications can take place (e.g. parameter selection logic modification, rule alteration, etc.) in order to improve results.

Action 728 is obtaining parameters that relate to presentation generation. In order to explain a manner in which a financial opportunity will be taken advantage of, a presentation is used to convey information. To create a beneficial presentation, parameters should be learned that could be used in creating the presentation. For instance, if a loan is to be provided to a group of deaf individuals, then sounds would likely not be useful and a parameter would be that sound should not be included in the presentation. Additionally, if a presentation is to be provided over a teleconference, action 728 can obtain parameters that relate to equipment that will be used in the teleconference (e.g., telephones without video capabilities, telephones with poor sound detail communication, etc.). Parameters can be that visual effects should not be used and high detail sounds should not be used since they will likely not be conveyed by the equipment.

There is generating at least one presentation for pursuit of the financial opportunity 730. A common presentation includes gathered information, inferences made from gathered information, statistics and probabilities that relate to the financial opportunity, suggested and alternative products and services, etc. Example presentations include computer slide shows, pamphlets, pitchbooks, etc. A system operating the methodology 700 can use internal logic mechanisms to determine how to configure the presentation in view of obtained parameters.

Obtaining personal statistics concerning the presentation 732 occurs. In a company, different employees can have varying backgrounds, experiences, contacts, skill sets, etc. Event 732 gathers statistical information for at least one person; statistics disclose different traits related to a person. If an individual has a history of closing small financial opportunities for a profit though mechanisms disclosed in the subject specification, then information concerning the success is gathered and used in other actions to attempt to place the person on a proper team.

Event 734 is performing at least one scheduling task related to the presentation. Various scheduling capabilities can become important when determining how a presentation can be disclosed. For instance, conventionally it can be beneficial for a Chief Executive Officer (CEO) to disclose a presentation. However, many CEOs have limited amounts of time and cannot dedicate time to small transactions. Therefore, a scheduling task can be to evaluate priority of time scheduled to a person and determining if the person can be dedicated to the presentation (e.g., slotted to disclose the presentation).

Act 736 is creating a presentation team, where a team is one or more individuals and/or entities. A team is created that divulges the presentation (e.g., three people lead a discussion with the presentation as a guide, one person arranges meetings and makes initial contacts while another provides the presentation, a single person discloses the presentation, etc.) The created team is conventionally a function of characteristics of individuals, parameters of the presentation, scheduling constraints, etc. A team can also include equipment that is specifically dedicated to a team (e.g., a laser printer that the team can use in manufacturing a generated presentation.)

There is managing workflow related to the presentation 738. There can be a number of duties that relate to a presentation. For example, once a presentation is provided, follow-up correspondences can attempt to close a financial transaction. Event 738 can determine what should be done, what can be performed automatically, individuals (e.g., members of the team, support staff, etc.) that should perform specific workflow tasks, etc. Management can be dynamic that allows for changes as situations change.

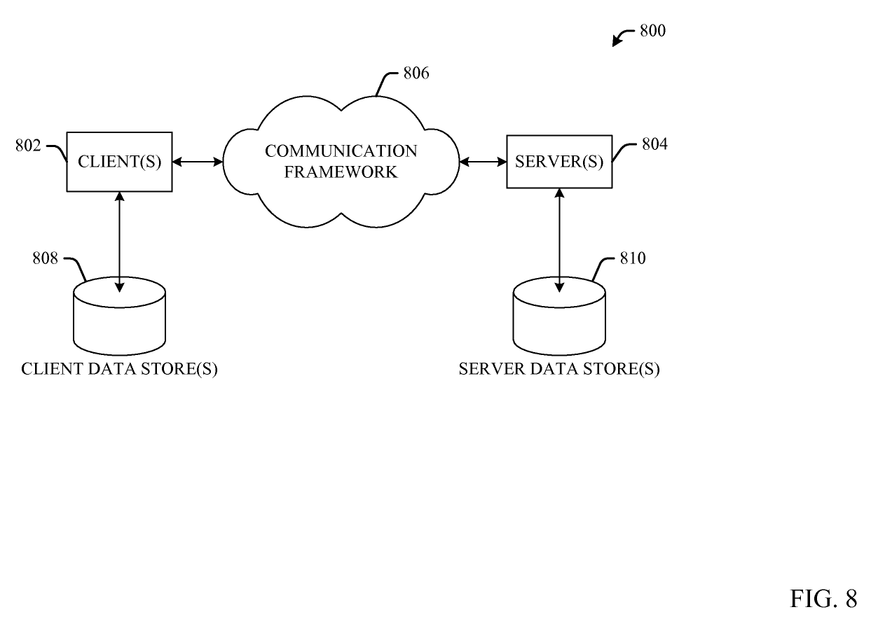

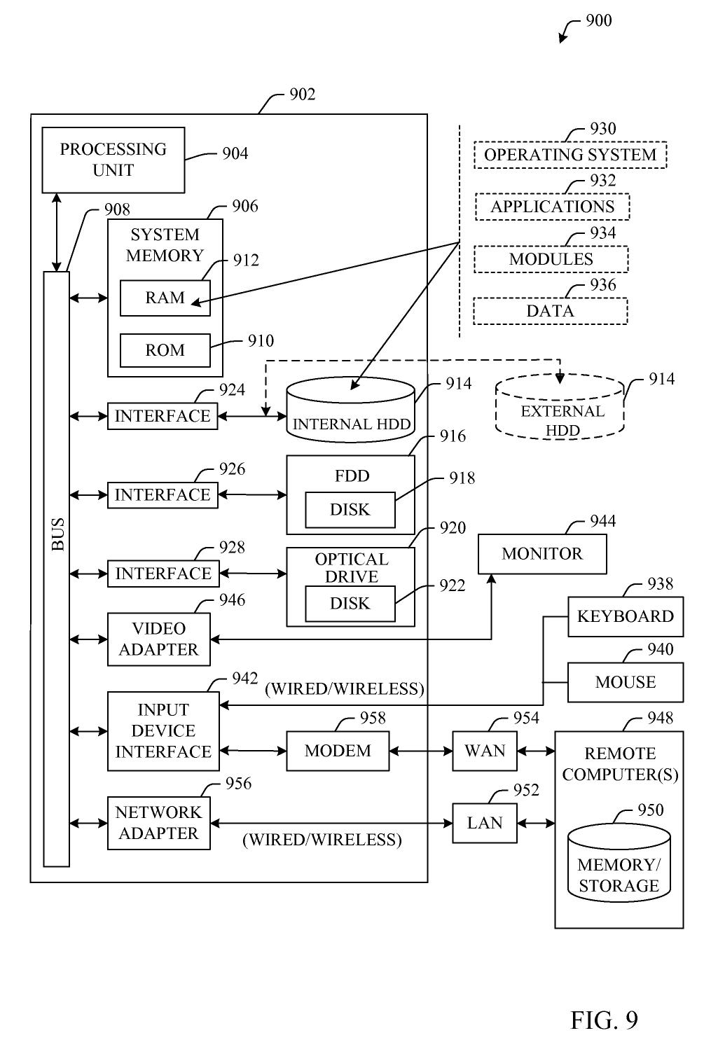

In order to provide a context for the various aspects of the disclosed subject matter, FIGS. 8 and 9 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 8, there is illustrated a schematic block diagram of a computing environment 800 in accordance with the subject specification. The system 800 includes one or more client(s) 802. The client(s) 802 can be hardware and/or software (e.g., threads, processes, computing devices). The client(s) 802 can house cookie(s) and/or associated contextual information by employing the specification, for example.

The system 800 also includes one or more server(s) 804. The server(s) 804 can also be hardware and/or software (e.g., threads, processes, computing devices). The servers 804 can house threads to perform transformations by employing the specification, for example. One possible communication between a client 802 and a server 804 can be in the form of a data packet adapted to be transmitted between two or more computer processes. The data packet can include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

Referring now to FIG. 9, there is illustrated a block diagram of a computer operable to execute the disclosed architecture. In order to provide additional context for various aspects of the subject specification, FIG. 9 and the following discussion are intended to provide a brief, general description of a suitable computing environment 900 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the example environment 900 for implementing various aspects of the specification includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the specification can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) can include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 is connected to the local network 952 through a wired and/or wireless communication network interface or adapter 956. The adapter 956 can facilitate wired or wireless communication to the LAN 952, which can also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are example and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that assists selection of at least one of a financial service or a financial product for pursuit of a financial opportunity, comprising:
at least one processor coupled to a memory, the processor executes:
a component that proactively appraises a fiscal prospect designated for engagement; and
a match component that selects at least one financial product or financial service for engagement of the fiscal prospect based at least in part on a result of the appraisal of the suitability of the fiscal prospect for the pursuit of the financial opportunity.

2. The system of claim 1, further comprising a configuration component that arranges at least one parameter related to the selected product or service.

3. The system of claim 1, further comprising an evaluation component that analyzes at least one financial service or at least one financial product, wherein a result of the analysis is used in selection of at least one financial product or financial service.

4. The system of claim 1, further comprising a cost component that provides economic data to the match component, wherein a subset of the economic data is used in the selection of at least one product or service.

5. The system of claim 1, further comprising an artificial intelligence component that makes at least one inference or at least one determination in relation to selection of at least one product or service.

6. The system of claim 1, further comprising a history component that evaluates previous interactions related to the fiscal prospect and provides historic data of the previous interactions to the match component, wherein a subset of the historic data is used in the selection of at least one product or service.

7. The system of claim 1, further comprising a partition component that assigns the selected product or service to an entity.

8. A method that facilitates selection of at least one of a financial service or a financial product for pursuit of a financial opportunity, comprising:
employing at least one processor to execute the following:
evaluating a characteristic of the selected financial product or financial service, the product or service characteristics are retained in a memory; and
configuring at least one evaluated characteristic in accordance with the pursuit of the financial opportunity, the financial opportunity has been proactively selected as a potential candidate for presentation of financial services or products.

9. The method of claim 8, further comprising determining at least one attribute of the financial opportunity, wherein configuration of the evaluated characteristic is based on the at least one determined attribute.

10. The method of claim 8, wherein the configuration takes place in accordance with at least one economic factor.

11. The method of claim 8, further comprising retaining configuration data, wherein the retained configuration data is used in a subsequent configuration of at least one evaluated characteristic in accordance with pursuit of an economic occasion.

12. The method of claim 8, further comprising selecting at least one product or service for use in conjunction with pursuit of the financial opportunity.

13. The method of claim 12, further comprising collecting information or metadata that relates to the financial opportunity, wherein collected information or metadata is used in selecting at least one financial product or financial service.

14. The method of claim 8, further comprising authenticating at least one selected financial product or financial service.

15. A system to assist with selection of at least one of a service or a product for pursuit of a financial opportunity, comprising:
at least one processor coupled to a memory, the processor executing:
means for collecting information that associates with an entity, the entity has been proactively selected as a potential candidate for presentation of financial services or products; and
means for determining if a financial opportunity related to the entity should be pursued.

16. The system of claim 15, further comprising means for choosing at least one product or at least one service for pursuit of the financial opportunity.

17. The system of claim 15, further comprising means for managing workflow that relates to pursuit of the financial opportunity.

18. The system of claim 15, further comprising means for assigning a portion of time of at least one person, wherein the assigned portion of time is dedicated to pursuit of the financial opportunity.

19. The system of claim 15, further comprising means for generating a presentation for use in pursuit of the financial opportunity.

20. The system of claim 15, further comprising means for referring the financial opportunity to an external processor upon determination that the financial opportunity is not to be pursued in-house.
